(19) United States
(12) Patent Application Publication
(10) Pub. No.: US 2005/0061569 A1
(43) Pub. Date: Mar. 24, 2005

(54) Electrostimulation device for users of means of transport

(76) Inventors: Paolo Pascolo, Udine (IT); Carlo Pascolo, Udine (IT)

Correspondence Address: STEVENS DAVIS MILLER & MOSHER, LLP, 1615 L STREET, NW, SUITE 850, WASHINGTON, DC, 20036, US

(21) Appl. No.: 10/498,219

(22) PCT Filed: Dec. 11, 2002
(86) PCT No.: PCT/IB02/05274

(30) Foreign Application Priority Data
Dec. 12, 2001 (IT) UD2001A000206

(51) Int. Cl. B60D 1/28

(52) U.S. Cl. 180/271

(57) ABSTRACT

Electrostimulation device to prevent damage and traumas to users of a means of transport, comprising stimulation apparatus able to be associated with particular parts of the body of the users of the means of transport and governed by one or more sensors able to detect variations in particular parameters of the conditions of use of the means of transport.

### FIELD OF THE INVENTION

The present invention concerns an electrostimulation device which can be used to prevent physical damage to users of a means of transport, whether it be a vehicle used on the ground, a boat or an aircraft. The electrostimulation device according to the invention is able to transmit at least an electric impulse to one or more parts of the body of a user when there is a sudden acceleration or deceleration of the means of transport on which the user is travelling, such as when it suffers a sudden impact, or in the event that the user is ejected from the cockpit in the case of an aircraft, or in other similar or comparable cases.

The device according to the present invention is able to cause a localized contraction of the muscles of part of the user's body almost instantaneously by means of said electric impulse and in this way, in the event of impacts and knocks and/or other high acceleration stresses (high number of g where g=gravity acceleration), prevents and/or reduces traumas of the body, such as those deriving for example from the whiplash effect.

### BACKGROUND OF THE INVENTION

The Applicant is not aware of devices installed or board a means of transport which can be used to protect and safeguard drivers and passengers of vehicles from the damage caused, for example, by the so-called whiplash effect, which a human being suffers as a consequence of a violent counter-blow due to a sudden and unexpected acceleration or deceleration of the vehicle, (an automobile, an aircraft, a boat, a train, a bus or suchlike), for example in the case of an impact in an accident, or when the user is ejected from a cockpit of an aircraft, or because of other manoeuvres, for example in military aircraft, which entail violent variations in speed.

In the specific case of an automobile, there are known, for example from the article by R. L. Phen et al, “Advanced Air bag Technology Assessment—Final Report”, devices to protect the users, such as airbags, which in any case do riot help to protect the person from the whiplash effect but which serve to prevent or reduce the impact of the driver or passenger against parts of the driver's compartment of the vehicle in the event of a crash.

Moreover the reaction times of a human being (psycho-technical reaction time) in the case of a crash are, at best, in the range of 3 tenths of a second, while the average value is in the range of 0.765 seconds. These values are high and altogether insufficient to react against an unexpected and potentially dangerous event. For this reason the human being cannot avoid considerable damage and traumas like those caused, for example, by the whiplash effect, in the case of a violent impact or crash or sudden accelerations.

The Applicant has devised and embodied the present invention to overcome this shortcoming and to obtain further advantages.

### SUMMARY OF THE INVENTION

The present invention is set forth and characterized essentially in the main claim, while the dependent claims describe other innovative characteristics of the invention.

The purpose of the invention is to achieve an electrostimulation device which can be used to protect and/or safeguard drivers and passengers in vehicles, trains, aircraft, boats or other moving means such as the most recent fairground attractions where the user is subjected to violent accelerations and decelerations.

In accordance with this purpose, an electrostimulation device to prevent damage to users of a means of transport according to the present invention comprises sensor means able to detect anomalous variations in particular parameters of the conditions of use of the means of transport, and stimulation means governed by such sensor means and associated with one or more particular and localized parts of the body of the users of the means of transport.

In a preferential embodiment, the device according to the present invention also comprises a processing and control unit which is able to process the signals generated by the sensor means and to generate correlated stimulation signals for one or more of said stimulation means.

The means of transport in which the device according to the present invention can be used are vehicles such as automobiles, trucks, coaches, etc., motor vehicles or other individual or collective means of transport such as trains or planes, both civilian and military.

In the functioning of the device, the sensor means are connected to the processing and control unit from which one or more electrodes branch off. The electrodes are positioned in such a manner as to selectively excite defined parts of the muscles of parts of the human body such as for example the head, neck, trunk, limbs or other parts, so as to determine an almost instantaneous contraction thereof as a consequence of a sudden impact detected by the sensor means and/or because of stresses of other types due to a high acceleration or deceleration. Such contraction allows the user to be prepared, for example, for a sudden variation in the speed of the means of transport in which he is travelling so as to minimize the consequences of the traumatic incident.

It has been proved in experiments that, given the same variation in speed, a suitably stimulated person can reduce the oscillations of the head up to 70%, and hence the state of stress of the cervical rach is compared to the same person who has not been electrostimulated.

The action of the electrostimulation device, in some cases, can also partly compensate for the variation in the range of the blood pressure.

The sensor means can be distributed in different parts of the means of transport: for example, in the case of an automobile, they can be inserted in the seat, the dashboard, or in the front or rear part of the body work, whereas in the case of motorcycles they can be inserted in the motorcycle itself and/or in the rider's helmet.

In the case of aircraft, apart from the positions mentioned above, the sensor means can be inserted into the nacelle, or associated with various members to pilot, or to eject the pilot from, the aircraft.

The sensor means can be of various shape and are connected, by means of cables and connectors, to the processing and control unit and by means of this to the stimulation means.

According to a variant, the connection between the sensor means and the processing and control unit and/or between the latter and the stimulation means occurs via radio, by means of ultrasounds or infra-red rays.

The sensor means are of the type able to detect a sudden variation in the conditions of use of the means of transport and can comprise for example accelerometers, inclinometers and sensors of other types. The sensor means are able to send a signal to the processing and control unit to activate the stimulation electrodes, with a consequent emission of an electric impulse which acts locally on the nervous system and on the muscles of the user.

In a preferential form of embodiment the processing and control unit comprises at least a programmable microprocessor.

In this preferential form of embodiment the sensor means can easily be interfaced, for example in the case of automobiles, with those of a device to activate at least an airbag.

The stimulation means can be positioned according to a variable mapping depending on the type of user, to take into account individual variability. In the simplest cases, when the paravertebral muscles are excited, the stimulation means comprise electrodes which are positioned in a variable manner. For example there can be from two to sixteen electrodes and hence from one to eight channels. In a particular case, there may be a single outlet with two electrodes. In the particular case of aircraft, there may be more than 16 electrodes, and their number will depend substantially on the parts of the body which are to be stimulated.

The positioning of the stimulation electrodes depends on which muscles are to be excited, for example the rear muscles of the head, the neck and the shoulders, the trunk and the limbs, according to the type of situation and problem to be dealt with.

In a preferential embodiment, the electrodes are distributed so that they start the stimulation below the C3 vertebra in order to prevent influence on the brain (electric shock).

In another preferential embodiment, the electrodes are distributed so that they stimulate the neck muscles in correspondence, for example, with the center line of the backbone for a maximum width of 3.5÷4 cm between vertebra C3 and C7.

In another preferential embodiment, the electrodes are distributed so that they stimulate the shoulder muscles from vertebra C7 to T1 and comprise the middle trapezius muscle for the whole width of the shoulders.

For other purposes, for example to control the range of the blood pressure, the electrodes can be positioned so as to stimulate all or a large part of the muscles.

According to the type of compartment and the type of stress which is to be reduced or from which the driver or passenger is to be protected, for example head-on and/or rear impact rather than a fall from a motorcycle or a simple whiplash, the electrodes can be positioned differently on the person and using different methods.

According to further variants, the electrodes can be inserted according to the vehicle, where the device according to the present invention is used, in rear pads of a helmet, in a collar, in soft, hidden fork-shaped supports in the head-rest of an automobile, on the arms of glasses or also in metal extensions or branches integrated into the head-rest or in the cushion associated with a seat, or suchlike.

In the preferential embodiment of the invention, the impulses which can be applied are variable in amplitude, width, frequency of application, with or without the negative impulse.

Preferential values of the electric impulses generated are generally within a difference in potential of between 50÷250 V, with a frequency of between 15÷170 Hz, with a width of between 10÷400 μs and a current intensity of between 1÷100 mA.

### BRIEF DESCRIPTION OF THE DRAWINGS

These and other characteristics of the invention will be apparent from the following description of a preferential form of embodiment, given as a non-restrictive example, with reference to the attached drawings wherein:
FIG. 1 is a schematic view of a means of transport wherein an electrostimulation device according to the invention in installed according to one embodiment;
FIG. 2 shows a variant of FIG. 1;
FIG. 3 is a schematic view of an electrostimulation device as shown in FIG. 2 applied in another means of transport;
FIG. 4 is a block diagram of the processing and control unit contained in the device shown in FIG. 1;
FIG. 5 is a schematic view of the electrostimulation device in FIG. 1 applied in an aircraft.

### DETAILED DESCRIPTION OF SOME PREFERENTIAL FORMS OF EMBODIMENT OF THE INVENTION

With reference to FIGS. 1 and 4, an electrostimulation device 10 according to the present invention comprises a processing and control unit 13, and is connected to and installed in an automobile 16.

The electrostimulation device 10 is able to prevent the so-called whiplash effect to a user in the event of a possible accident, impact or sudden acceleration/deceleration of another type. The device 10 comprises in its essential parts sensor elements 12 consisting, in this case, of a first accelerometer 12a installed in the front part of the automobile 16, and a second accelerometer 12b installed in the rear part, an airbag unit 14, the processing and control unit 13 (shown in detail in FIG. 4), a feeder unit 22 and a pair of electrodes 15, mounted on a collar suitable to keep the electrodes 15 stably in contact on the user's head. The first and second accelerometer 12a and 12b are positioned to respectively detect sudden accelerations or decelerations caused by impacts from the front or rear.

It is clear that the use of accelerometers 12a and 12b is only an example, and any type of sensor 12 suitable for the purpose can be used, for example an inclinometer or other type of analogous or comparable sensor. It is also clear that the representation of the electrodes mounted on the collar is an example, and can be replaced, according to a variant, by a helmet 34 (FIG. 3), by fixed electrodes mounted on the head-rest, on the seat, or on another part of the automobile 16 or by any other configuration suitable for the purpose.

In the embodiment shown in FIG. 1, each of the electrodes 15 is fixed to the end of connection cables 18 and is connected by a connector 17 to the processing and control unit 13 located in the front portion of the automobile 16, in this case in front of the driver's position. The pair of electrodes 15, thanks to the cables 18, can be applied to the neck of a user driving on the seat 19 of the automobile 16.

According to a variant not shown in the drawing, the processing and control unit 13 is connected by means of connection cables 18 and the connector 17 also to other pairs of electrodes 15 suitable to reach any one of the seats of the automobile 16.

The first accelerometer 12a and the second accelerometer 12b are sensors to detect accelerations (positive or negative), for example of the monoaxial type model M352C68 by PCB Piezotronics, which emits a tension signal when it detects an acceleration.

The processing and control unit 13 is able to evaluate the acceleration threshold and then establishes whether to generate an activation signal or not.

The processing and control unit 13 shown in FIGS. 1-2 is connected by means of electric connection cables 18 to the first and second accelerometer 12a, 12b and to the device to activate the airbag 14, of a conventional type.

With reference to FIG. 4, the accelerometers 12a, 12b and the system to activate the airbag 14 are connected to the terminals at inlet to the processing and control unit 13.

According to a variant, the processing and control unit 13 is independent from the device to activate the airbag 14.

According to another variant, the terminals at inlet to the processing and control unit 13 are connected to other sensors, indicated by a line of dashes in FIG. 4, for example inclinometers 26.

In this form of embodiment the processing and control unit 13 comprises a first reception and adaptation block 20 by means of which the electric signal arriving from the various sensors (for example 12a, 12b, 26 . . . ) connected is transmitted to a programmable microprocessor 21.

The block 20 and/or the programmable microprocessor 21 can be regulated so that an electric signal arriving from a sensor 12, or group of sensors 12, is dominant with respect to another.

The programmable microprocessor 21 comprises, in its essential parts, developed through processing, an AND/OR logical matrix 23, a timer block 24 and an impulse generator block 25.

The signals arriving from the accelerometers 12a, 12b and/or the signal arriving from the unit to activate the airbag 14, in the event of a sudden deceleration or an impact from front or rear, are recognized and validated by the programmable microprocessor 21, in correspondence with the AND/OR logical matrix 23. The latter is suitable to activate the timer block 24 which is able to determine the time for which electrostimulation has to be applied to the user, in response to the stress detected by the accelerometers 12a, 12b.

The timer block 24 then activates the impulse generator 25 which provides to make the outlet power unit 27 produce the stimulation current.

In this way the cable connection 18 carries the stimulation impulses to the two electrodes 15 inserted On the collar.

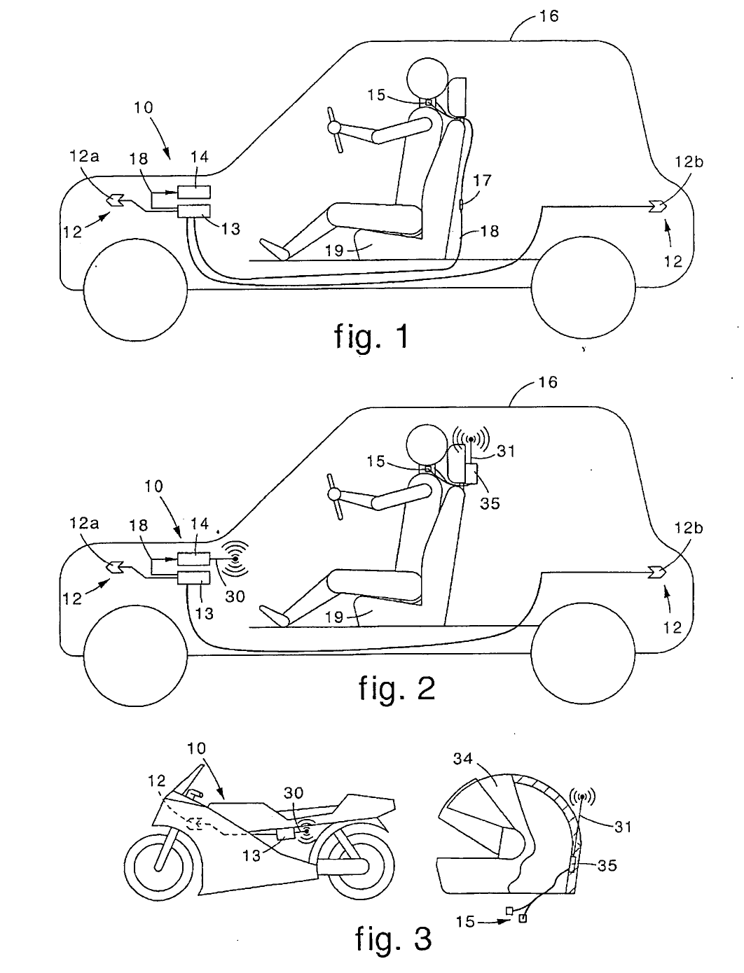

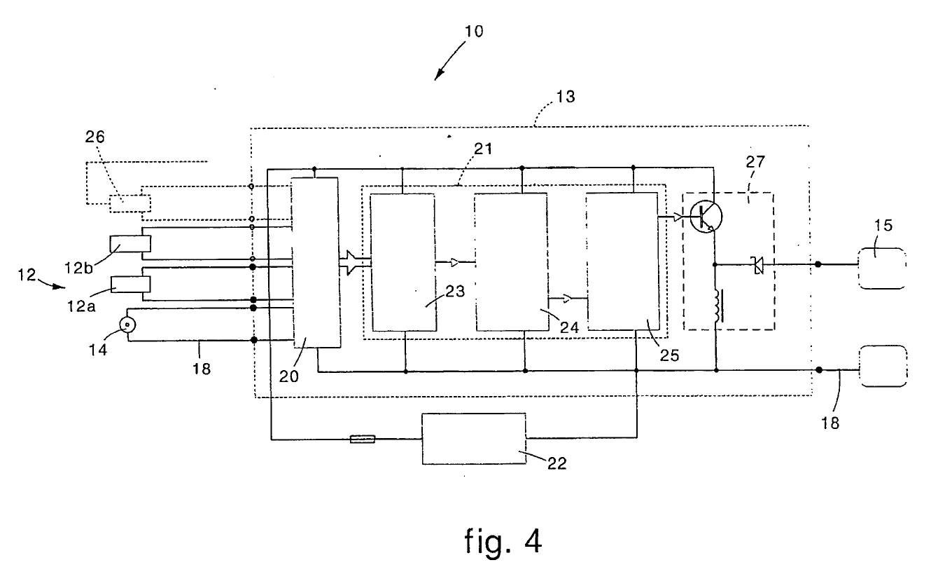

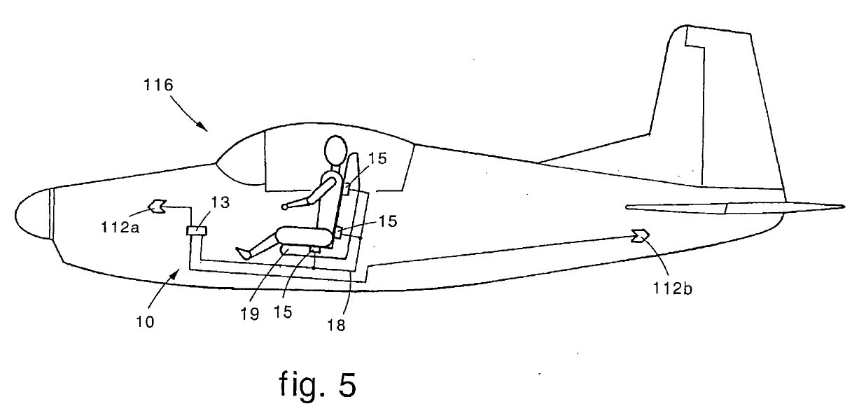

In the embodiment shown in FIG. 5, the electrostimulation device 10 as described heretofore is installed in an aircraft 116 equipped with a seat 19 associated with ejection means. In this case a plurality of electrodes 15 are associated with the seat 19 and act in cooperation with various parts of the pilot's body, to prevent any damage deriving from the violent acceleration caused by the ejection of the seat 19, or by other anomalous situations which can occur, for example during take-off, landing or otherwise. In the case shown schematically here, a first sensor 112a and a second sensor 112b are arranged in different zones of the aircraft 116, to detect situations which cause sudden accelerations or decelerations to which the pilot or a possible passenger is subject.

For example, a first sensor 112a can be associated directly with the seat 19 and can detect when the ejector mechanism is engaged, and send the relative signal to the processing and control unit 13 in order to activate the electrodes 15 which perform the electrostimulation. The second sensor 112b can be located at any point of the nacelle, and can be an accelerometer or inclinometer or a sensor of another type, which detects anomalous situations concerning the functioning of the aircraft, for example a crash, a sudden drop in altitude, a violent inclination, a sudden acceleration or other problem.

According to a further variant indicated in FIGS. 2-3, the processing and control unit 13 comprises a signal transmission circuit via radio and a transmission antenna 30 The electrodes 15, connected to a device 35 comprising an antenna 31 to receive the radio signal and at least a signal converter and an impulse generator, are positioned on a seat 19 of the automobile 16 in FIG. 2 or on a helmet 34 in FIG. 3.

In this way the connection between the processing and control unit 13 and the electrodes 15 occurs via radio, so as to reduce the number of cables between the processing and control unit 13 and the points where the electrodes 15 are positioned.

It is clear however that modifications and/or additions of parts can be made to the device 10 as described heretofore without departing from the field and scope of the present invention.

For example the circuit which comprises the processing and control unit 13, instead of comprising a programmable microprocessor 21, can simply be made with elements of a traditional electric or electronic type.

Further, in another embodiment, the stimulation means can comprise not electrodes 15 provided in continuous contact with parts of the user's body, but they can consist of delivering means for delivering a conductive fluid, i.e. clouds and/or sprays of a conductive gas, or jets of liquid, also nebulized, having property of electric conduction, such as saltwater or like.

In the same manner as above for the solution with the electrodes 15, the stimulation means are activated by the detection of a sudden acceleration/deceleration in order to deliver such a conductive fluid towards one or more parts of the body, activating in the user the above described electrostimulation mechanism of the muscles.

The delivering means can be mounted on any suitable position of the vehicle or of the user's equipment, for example installed and/or integrated in the seat 19, in a head-rest, in a helmet 34, in a part of the body work, or of the dashboard, or others.

It is also clear that, although the invention has been described with reference to specific examples, a person of skill in the art shall certainly be able to achieve many other equivalent forms of electrostimulation device, all of which shall come within the field and scope of the present invention.

1. Electrostimulation device to prevent damage and traumas to users of a means of transport, comprising sensor means able to detect variations in particular parameters of the conditions of use of said means of transport, stimulation means able to be associated with particular parts of the body of the users of said means of transport and governed by said sensor means in order to generate associated signals to stimulate said parts of the body of the user in response to the detection of anomalous situations in the parameters of functioning of said means of transport as detected by said sensor means.

2. Electrostimulation device as in claim 1, comprising a processing and control unit able to receive and process the signals transmitted by said sensor means and to condition the activation of said stimulation means in correlated manner.

3. Electrostimulation device as in claim 2, wherein said processing and control unit is suitable to activate said stimulation means by means of an electric signal transmitted through cables and connectors

4. Electrostimulation device as in claim 2, wherein said processing and control unit comprises transmission means to transmit radio waves and said stimulation means are associated with reception means to receive said radio waves.

5. Electrostimulation device as in claim 1, wherein said means of transport comprises an automobile, a motor vehicle, or other means able to transport persons individually or collectively.

6. Electrostimulation device as in any claim 1, wherein said anomalous situation comprises a sudden variation in speed, either positive or negative, or in inclination of said means of transport.

7. Electrostimulation device as in claim 1, wherein said stimulation means comprise at least an electrode able to be applied on at least a localized part of the body of a user in order to transmit at least an electric impulse to said part.

8. Electrostimulation device as in claim 7, wherein there are at least two electrodes to define at least a corresponding channel to transmit said electric impulse.

9. Electrostimulation device as in claim 8, wherein there are 16 or more electrodes.

10. Electrostimulation device as in claim 1, wherein said stimulation means comprise a single outlet with two electrodes.

11. Electrostimulation device as in claim 1, wherein said stimulation means are distributed in such a manner as to stimulate at least part of the paravertebral muscles of the head, of the neck and of the shoulders of said user.

12. Electrostimulation device as in claim 1, wherein said stimulation means are distributed in such a manner as to stimulate the part of the user's muscles which can affect the range of the blood pressure.

13. Electrostimulation device as in claim 1, wherein said stimulation means are inserted in the rear pads of a protection helmet (3), in a collar, in a seat or in soft, hidden fork-shaped supports of a head-rest in said means of transport or on the arms of the glasses of said user.

14. Electrostimulation device as in claim 7 wherein said electric impulse is variable in amplitude, width, frequency of application, with or without the presence of the negative impulse.

15. Electrostimulation device as in claim 14, wherein said electric impulse has a difference in potential of between 50 and 250 V, a frequency of between 15 and 170 Hz, a width of between 10 and 400 μs and a current intensity of between 1 and 100 mA.

16. Electrostimulation device as in claim 1, wherein said sensor means are able to be interfaced in said means of transport with sensor means associated with a device to activate at least an airbag or at least an ejector seat.

17. Electrostimulation device as in claim 1, wherein said sensor means are able to be positioned in a seat or on the dashboard of a vehicle, in the nacelle or associated with members to pilot an aircraft.

18. Electrostimulation device as in claim 1, wherein said sensor means are able to be positioned in a seat of a motorcycle and/or in association with a rider's helmet.

19. Electrostimulation device as in claim 2 wherein said processing and control unit comprises at least a programmable microprocessor.

20. Electrostimulation device as in claim 19, wherein said programmable microprocessor comprises a processing logical matrix, a timer block and an impulse generating block, associated with said stimulation means.

21. Electrostimulation device as in any claim 1 wherein said stimulation means comprise delivering means able to deliver a conductive fluid towards one or more parts of the user's body.

22. Electrostimulation device as in claim 21, wherein said conductive fluid comprises a conductive gas or liquid.

23. Electrostimulation device as in claim 22, wherein said conductive liquid is delivered in a nebulized form.

24. Electrostimulation device as in claim 21, wherein said delivering means are installed and/or integrated in a part of the vehicle or of the user's equipment.

25. Electrostimulation device as in claim 1, wherein said means of transport comprises a train, a civilian plane or a military plane.

26. Electrostimulation device as in claim 21, wherein said conductive fluid comprises saltwater.

27. Electrostimulation device as in claim 21, wherein said delivering means are installed and/or integrated in at least one part of the vehicle or of the user's equipment selected from the group consisting of a seat, a head-rest, a helmet, body work, and a dashboard.
